(19) United States
(12) Patent Application Publication
(10) Pub. No.: US 2024/0111575 A1
(43) Pub. Date: Apr. 4, 2024

(54) Synchronization Method for Low Latency Communication for Efficient Scheduling

(71) Applicant: Advanced Micro Devices, Inc., Santa Clara, CA (US)

(72) Inventors: Matthäus G. Chajdas, Munich (DE); Michael J. Mantor, Orlando, FL (US); Rex Eldon McCrary, Orlando, FL (US); Christopher J. Brennan, Boxborough, MA (US); Robert Martin, Boxborough, MA (US); Dominik Baumeister, Munich (DE); Fabian Robert Sebastian Wildgrube, Munich (DE)

(21) Appl. No.: 17/936,798

(22) Filed: Sep. 29, 2022

(51) Int. Cl. G06F 9/48; G06F 9/54

(52) U.S. Cl. CPC G06F 9/4881; G06F 9/546

(57) ABSTRACT

Systems, apparatuses, and methods for implementing a message passing system to schedule work in a computing system. In various implementations, a processor includes a global scheduler, and a plurality of local schedulers with each of the local schedulers coupled to a plurality of processors. The processor further includes a shared cache that is shared by the plurality of local schedulers. Also, a plurality of mailboxes are implemented to enable communication between the local schedulers and the global scheduler. To schedule work items for execution, the global scheduler is configured to store one or more work items in the shared cache and store an indication in a mailbox for a first local scheduler of the plurality of local schedulers. Responsive to detecting the message in the mailbox, the first local scheduler identifies a location of the one or more work items in the shared cache and retrieves them for scheduling locally.

### BACKGROUND

### Description of the Related Art

Graphics processing applications often include work streams of vertices and texture information and instructions to process such information. The various items of work (also referred to as “commands”) may be prioritized according to some order and enqueued in a system memory buffer to be subsequently retrieved and processed. Schedulers receive instructions to be executed and generate one or more commands to be scheduled and executed at, for example, processing resources of a graphics processing unit (GPU).

In conventional parallel processors for hierarchical work scheduling, local schedulers may communicate with a global scheduler using a shared memory. Such mechanisms for communication can cause issues, e.g., high latency as well as a need to emulate certain primitives with atomics and spin locks. The amount of memory available may be limited and scaling of the system could therefore cause increased overhead in sending messages between individual schedulers. Further, using the main memory subsystem has limitations in that heavyweight primitives may have to be used in order to realize message passing. For example, in some cases, the memory subsystem may not have 16-bytes available for an atomic operation. In such cases, the system needs to use atomics on, for example, four bytes and then write the remaining eight bytes somewhere else. This might force performing a lock in the memory subsystem which is generally unfavorable.

In view of the above, improved systems and methods for simpler message passing mechanisms with low latency and high efficiencies are needed.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one implementation of a computing system.

FIG. 2 is a block diagram of one implementation of a graphical processing unit.

FIG. 3 is a block diagram illustrating a parallel processor implementing hierarchical schedulers.

FIG. 4 is a generalized flow diagram illustrating hierarchical scheduling of work items.

FIG. 5 is a generalized flow diagram illustrating local scheduling of work items in a parallel processor.

FIG. 6 is a generalized flow diagram illustrating a method of launching work items by a local dispatch controller.

FIG. 7 is a generalized flow diagram illustrating a method of global work scheduling by a processor.

FIG. 8 is a generalized flow diagram illustrating a method for passing messages by a global scheduler using a dedicated mailbox.

FIG. 9 is a generalized flow diagram illustrating a method for passing messages by local schedulers using a dedicated mailbox.

FIG. 10 illustrates a 2-mailbox system for passing messages between individual schedulers.

FIG. 11 illustrates a single mailbox system for passing messages between individual schedulers.

### DETAILED DESCRIPTION OF IMPLEMENTATIONS

In the following description, numerous specific details are set forth to provide a thorough understanding of the methods and mechanisms presented herein. However, one having ordinary skill in the art should recognize that the various implementations may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Systems, apparatuses, and methods for implementing communication in hierarchical scheduler of a computing system are described herein. In various implementations, a processor includes a global scheduler, and a plurality of local schedulers with each of the local schedulers coupled to a plurality of processors. In one implementation, the processor is a graphics processing unit and the processors are computation units. The processor further includes a shared cache that is shared by the plurality of local schedulers. Each of the local schedulers also includes a local cache used by the local scheduler and processors coupled to the local scheduler. A plurality of mailboxes is implemented to enable communication between the local schedulers and the global scheduler. To schedule work items for execution, the global scheduler is configured to store one or more work items in the shared cache and store an indication in a mailbox for a local scheduler of the plurality of local schedulers. Responsive to detecting the message in the mailbox, the local scheduler identifies a location of the one or more work items in the shared cache and retrieves them for scheduling locally. When communicating with the global scheduler, the local scheduler is configured to store a message in a mailbox used by the global scheduler. The local scheduler is configured to convey a plurality of types of messages, including, but not limiting to, push messages, work steal messages, messages indicating availability of new work items, etc.

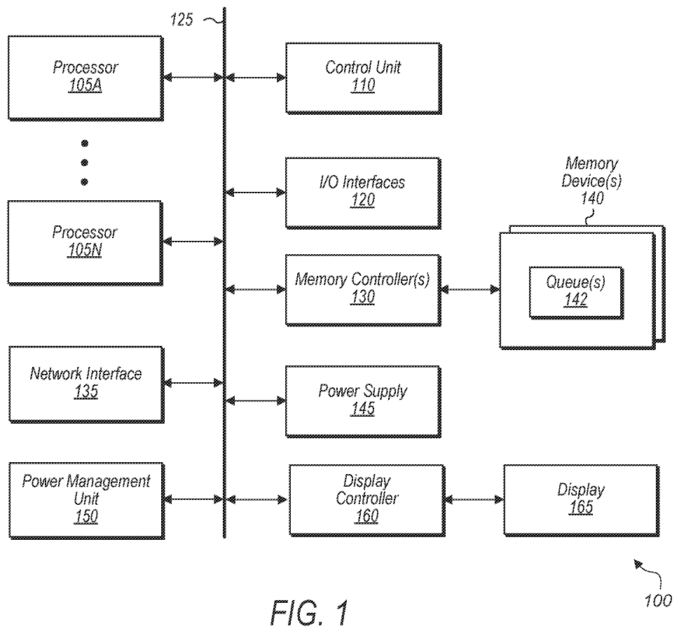

Referring now to FIG. 1, a block diagram of one implementation of a computing system 100 is shown. In one implementation, computing system 100 includes at least processors 105A-N, control unit 110, input/output (I/O) interfaces 120, bus 125, memory controller(s) 130, network interface 135, memory device(s) 140, power supply 145, power management unit 150, display controller 160, and display 165. In other implementations, computing system 100 includes other components and/or computing system 100 is arranged differently. Processors 105A-N are representative of any number of processors which are included in system 100, with the number of processors varying from implementation to implementation.

In one implementation, processor 105A is a general purpose processor, such as a central processing unit (CPU). In one implementation, processor 105N is a data parallel processor with a highly parallel architecture. Data parallel processors include graphics processing units (GPUs), digital signal processors (DSPs), field programmable gate arrays (FPGAs), application specific integrated circuits (ASICs), and so forth. In one implementation, processor 105N is a GPU which provides pixels to display controller 160 to be driven to display 165. In some implementations, processors 105A-N include multiple data parallel processors. In one implementation, control unit 110 is a software driver executing on processor 105A. In other implementations, control unit 110 includes control logic which is independent from processors 105A-N and/or incorporated within processors 105A-N. Generally speaking, control unit 110 is any suitable combination of software and/or hardware.

Memory controller(s) 130 is representative of any number and type of memory controllers accessible by processors 105A-N. Memory controller(s) 130 is coupled to any number and type of memory devices(s) 140. Memory device(s) 140 are representative of any number and type of memory devices. For example, the type of memory in memory device(s) 140 includes Dynamic Random Access Memory (DRAM), Static Random Access Memory (SRAM), NAND Flash memory, NOR flash memory, Ferroelectric Random Access Memory (FeRAM), or others.

I/O interfaces 120 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices (not shown) are coupled to I/O interfaces 120. Such peripheral devices include (but are not limited to) displays, keyboards, mice, printers, scanners, media recording devices, external storage devices, network interface cards, and so forth. Network interface 135 is used to receive and send network messages across a network. Bus 125 is representative of any type of bus or fabric with any number of links for connecting together the different components of system 100.

In one implementation, queue(s) 142 are located in memory devices(s) 140. In other implementations, queue(s) 142 are stored in other locations within system 100. Queue(s)142 are representative of any number and type of queues which are allocated in system 100. In one implementation, queue(s) 142 store rendering tasks that are to be performed for frames being rendered. In one implementation, the rendering tasks are enqueued in queue(s) 142 based on inputs received via network interface 135. For example, in one scenario, the inputs are generated by a user of a video game application and sent over a network (not shown) to system 100. In another implementation, the inputs are generated by a peripheral device connected to I/O interfaces 120.

In one implementation, power management unit 150 manages the supply of power from power supply 145 to components of system 100, and power management unit 150 controls various power-performance states of components within system 100. Responsive to receiving updates from control unit 110, the power management unit 150 causes other components within system 100 to either increase or decrease their current power-performance state. In various implementations, changing a power-performance state includes changing a current operating frequency of a device and/or changing a current voltage level of a device. When the power-performance states of processors 105A-N are reduced, this generally causes the computing tasks being executed by processors 105A-N to take longer to complete.

In one implementation, control unit 110 sends commands to power management unit 150 to cause one or more of processors 105 to operate at a relatively high power-performance state responsive to determining that a number of tasks for the processor exceeds a threshold, needs to meet a certain quality of service requirement, or otherwise.

In various implementations, computing system 100 is a computer, laptop, mobile device, server, or any of various other types of computing systems or devices. It is noted that the number of components of computing system 100 varies from implementation to implementation. For example, in other implementations, there are more or fewer of each component than the number shown in FIG. 1. It is also noted that in other implementations, computing system 100 includes other components not shown in FIG. 1 and/or one or more of the components shown in computing system 100 are omitted. Additionally, in other implementations, computing system 100 is structured in other ways than shown in FIG. 1.

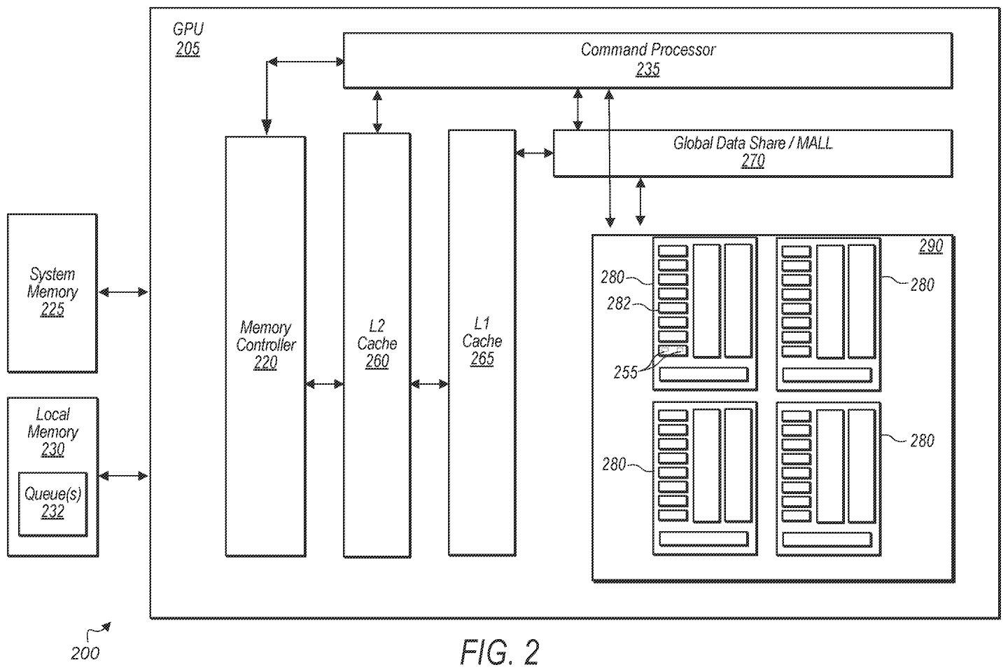

Turning now to FIG. 2, a block diagram of another implementation of a computing system 200 is shown. In one implementation, system 200 includes GPU 205, system memory 225, and local memory 230 which belongs to GPU 205. System 200 also includes other components which are not shown to avoid obscuring the figure. GPU 205 includes at least command processor 235 (also referred to as a “global scheduler”), shader engines 280, memory controller 220, shared cache 270, level one (L1) cache 265, and level two (L2) cache 260. In one implementation, each of the shader engines 280 includes a plurality of workgroup processors 282, with each including one or more compute units 255. In various implementations, each compute unit include one or more single-instruction-multiple-data (SIMD) processors. It is noted that compute units 255 can also be referred to herein as a “plurality of processing elements”. In other implementations, GPU 205 includes other components, omits one or more of the illustrated components, has multiple instances of a component even if only one instance is shown in FIG. 2, and/or is organized in other suitable manners. In one implementation, the circuitry of GPU 205 is included in processor 105N (of FIG. 1).

In various implementations, computing system 200 executes any of various types of software applications. As part of executing a given software application, a host CPU (not shown) of computing system 200 launches rendering tasks to be performed on GPU 205. Command processor 235 receives commands from the host CPU and issues corresponding rendering tasks to compute units 255. Rendering tasks executing on compute units 255 read and write data to global data share 270, L1 cache 265, and L2 cache 260 within GPU 205. Although not shown in FIG. 2, in one implementation, compute units 255 also include one or more caches and/or local memories within each compute unit 255. In various implementations, compute units 255 execute any number of frame-based applications which are rendering frames to be displayed, streamed, or consumed in real-time. In one implementation, queue(s) 232 are stored in local memory 230. In other implementations, queue(s) 232 are stored in other locations within system 200. Queue(s) 232 are representative of any number and type of queues which are allocated in system 200. In one implementation, queue(s) 232 store rendering tasks to be performed by GPU 205.

In one implementation, the performance setting of GPU 205 is adjusted based on a number of rendering tasks for the current frame stored in queue(s) 232 as well as based on the amount of time remaining until the next video synchronization signal. In various implementations, the performance setting of GPU 205 is adjusted so as to finish the rendering tasks before the next video synchronization signal while also achieving a power consumption target. In one implementation, the performance setting is adjusted by a control unit (not shown). The control unit can be a software driver executing on a CPU (not shown) or the control unit can include control logic implemented within a programmable logic device (e.g., FPGA) or control logic implemented as dedicated hardware (e.g., ASIC). In some cases, the control unit includes a combination of software and hardware.

In one implementation, the performance setting of GPU 205 corresponds to a specific power setting, power state, or operating point of GPU 205. In one implementation, the control unit uses dynamic voltage and frequency scaling (DVFS) to change the frequency and/or voltage of GPU 205 to limit the power consumption to a chosen power allocation. Each separate frequency and voltage setting can correspond to a separate performance setting. In one implementation, the performance setting selected by the control unit controls a phase-locked loop (PLL) unit (not shown) which generates and distributes corresponding clock signals to GPU 205. In one implementation, the performance setting selected by the control unit controls a voltage regulator (not shown) which provides a supply voltage to GPU 205. In other implementations, other mechanisms can be used to change the operating point and/or power settings of GPU 205 in response to receiving a command from the control unit to arrive at a particular performance setting.

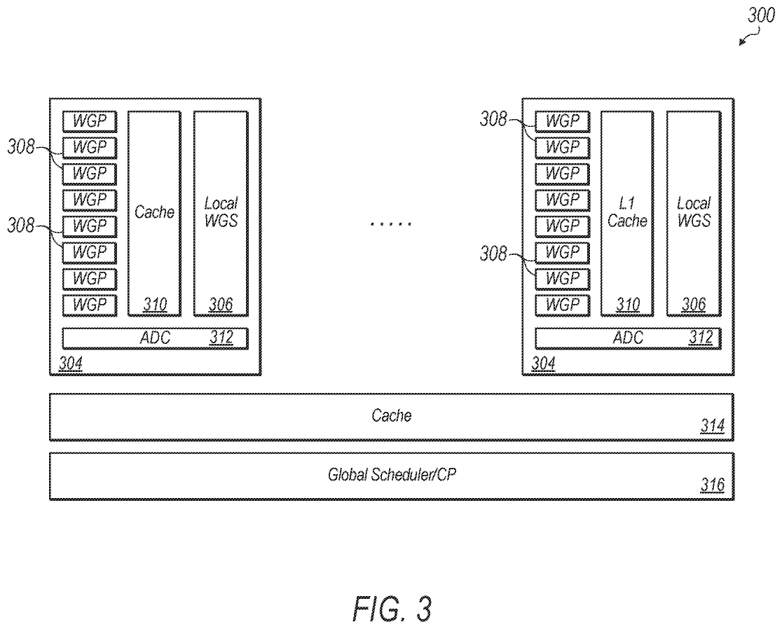

In various implementations, the shader engines 280 correspond to different scheduling domains. In an implementation, each shader engines 280 further includes a local workgraph scheduler (WGS) (also interchangeably referred to as a local scheduler), associated with a set of workgroup processors (WGP) 282, a local cache, and an asynchronous dispatch controller (ADC). The various schedulers and command processors described herein handle queue-level allocations. During execution of work, the WGS executes work locally in an independent manner. In other words, the workgroup scheduler of a given shader engine can schedule work without regarding to local scheduling decisions of other shader engines, i.e., the WGS does not interact with other WGS of other scheduling domains. Instead, the local scheduler uses a private memory region for scheduling and as scratch space. An example implementation of a processor including the above elements is illustrated in FIG. 3.

Turning now to FIG. 3, a parallel processor 300 implementing hierarchical scheduling domains is shown. In an implementation, the parallel processor 300 includes a plurality of scheduling domains 304. Each scheduling domain 304 corresponds to a shader engine. As shown, each shader engine 304 includes a plurality of workgroup processors (WGP) 308, with each including one or more compute units (not shown). Each of the shader engines 304 is configured to execute a plurality of work items received from a command processer (also referred to as a “global scheduler”) 316 external to the scheduling domain 304. In an implementation, each scheduling domain further includes a local workgraph scheduler (WGS) 306 (or “Local scheduler”), and a local cache 310. Each shader engine 304 further comprises an asynchronous dispatch controller (ADC) 312 configured to launch locally scheduled work for distribution of work items received by the global processor 316. In one implementation, the ADC 312 can execute launcher threads to the WGS 306 by picking one or more work items from an external cache 314. In various implementations, while each of shader engines 304 includes a local cache 310, cache 314 is shared by the shader engines 304. In this manner, data can be communicated between shader engines 304. In an exemplary implementation, each of the WGS and global scheduler may have access to individual mailboxes that may be used by a given entity to communicate with another entity in the system without the use of a main memory subsystem of the parallel processor 300. In one example, a dedicated mailbox 320 for the global scheduler may be located in cache 314. Further, each WGS 306 may also have a dedicated mailbox 322, which in one implementation, may be located in cache 310 associated with WGS 306. Other possible locations of the dedicated mailboxes are contemplated and are within the scope of the present disclosure.

In an implementation, the WGS 306 is configured to directly access the local cache 310, thereby avoiding the need to communicate through higher levels of the scheduling hierarchy. In this manner, scheduling latencies are reduced and a finer grained scheduling can be achieved. That is, WGS 306 can schedule work items faster to the one or more WGP 308 and on a more local basis. Further, the structure of the shader engine 304 is such that a single WGS 306 is available per shader 304, thereby making the shader engine 304 more easily scalable. For example, because each of the shader engines 304 is configured to perform local scheduling, additional shader engines can readily be added to the processor.

In operation, the WGS 306 is configured to communicate with the one or more WGP 308 via the local cache 310. The WGS 306 is further configured to receive a first set of work items from the global processor 316 and schedule the first set of work items for execution by the WGPs 308. In one implementation, the first set of work items are launched by the ADC 312 as wave groups via the local cache 310. The ADC 312, being located directly within the shader engine 304, builds the wave groups to be launched to the one or more WGPs 308. In one implementation, the WGS 306 schedules the work items to be launched to the one or more WGP 308 and then communicates a work schedule directly to the ADC 312 using local atomic operations (or “functions”). In an implementation, the scheduled work items are stored in one or more local work queues stored at the local cache 310. Further, the ADC 312 builds wave groups comprising the scheduled work items stored at the one or more local work queues, and then launches the scheduled work items as wave groups to the one or more WGP 308. In some implementations, however, one or more WGPs can also be configured to support a given local scheduler running on the WGS to offload processing tasks, thereby assisting the WGS in scheduling operations.

In an implementation, once the first set of work items are consumed at the one or more WGP 308, the WGS 306 may notify the global processor 316 through the external cache 314 using one or more global atomic operations. In one example, the WGS 306 writes an underutilization signal to the external cache 314 to indicate that it is currently being underutilized (i.e., is capable of performing more work than it is currently performing). The global processor 316 detects the underutilization indication by accessing the external cache 314. In one implementation, responsive to detection of such an underutilization indication, the global processor 316 is configured to identify a second set of work items for the WGS 306. In one example, the global processor 316 queries one or more different shader engines 302, in the same hierarchical level, to identify surplus work items from such one or more shader engines 302. Once such work items are identified, these work items are stored in the external cache 314, from where these are scheduled by the WGS 306 and launched by the ADC 312 to the one or more WGP 308.

As described in the foregoing, the parallel processor 300 comprises a plurality of shader engines 302, each having at least one WGS 306 for local scheduling operations. In one implementation, each WGS 306 in a given shader engine is configured to operate independently of WGS 306 in one or more other shader engine 302. That is, a WGS 306 for a given shader engine 302 does not communicate with other WGS 306 situated in another shader engine 302.

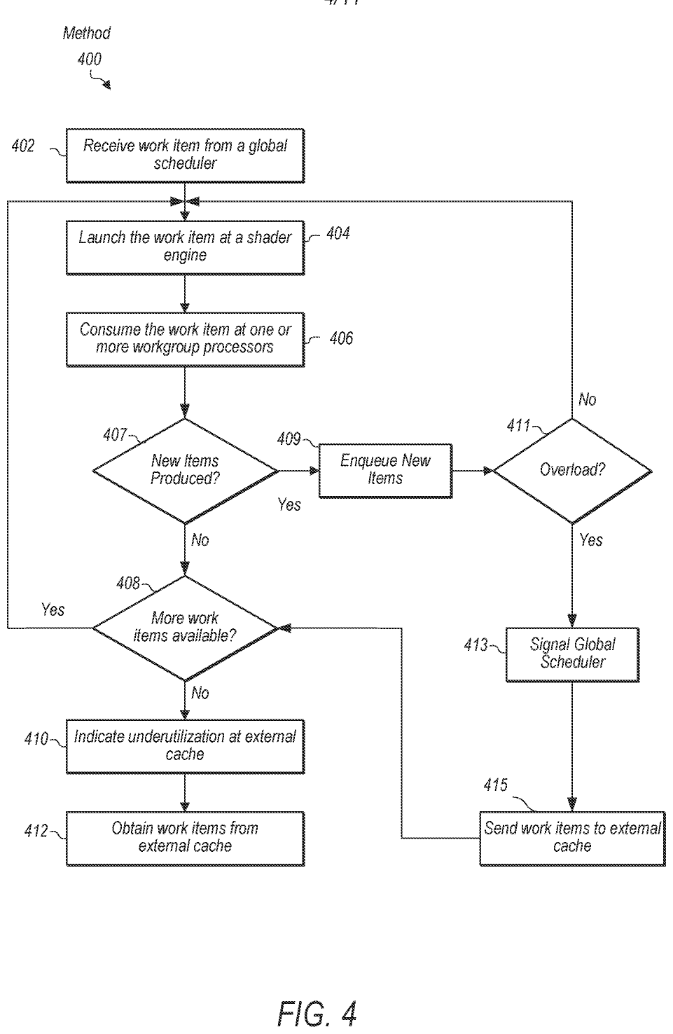

Turning now to FIG. 4, one implementation of a method 400 for scheduling of work items is shown. A local scheduler receives one or more work items from a global scheduler (block 402). In an implementation, the local scheduler is comprised within a shader engine of a parallel processor. The local scheduler, in one example, picks the one or more work items from an external cache associated with the global scheduler. Once the local scheduler obtains the work items for consumption, the local scheduler schedules new work items for execution by the workgroup processors of the shader engine. Dispatch of the work items to the workgroup processors is accomplished via an asynchronous dispatch controller (ADC) that dispatches/launches the one or more work items to one or more workgroup processors comprised within the shader engine (block 404). In one implementation, the local scheduler writes the work items to a local queue in a local cache of the shader engine, from which the ADC launches the work items to the one or more workgroup processors. In addition, WGPs are configured to allocate, deallocate, and use the local cache memory as needed during processing. In various implementations, if the identified work item(s) are too large to dispatch, the work is partitioned into smaller work items before enqueuing them for dispatch.

When the local scheduler has enqueued work items for dispatch, the local scheduler stores an indication (e.g., a command) for the ADC to indicate the work is ready. For example, commands may be enqueued in a command queue that is monitored by the ADC. When the ADC detects such a command, the ADC initiates a launch of the work items to the workgroup processors. In one implementation, the ADC communicates with the workgroup processors to identify where the work to be consumed is located within the local cache. In response to the indication from the ADC, the one or more work items can be consumed by the one or more workgroup processors (block 406). When a work item is processed by a workgroup processor, zero, one, or more new work items may be produced. If new items are produced (block 407), they are enqueued or otherwise locally stored (block 409) and a determination is made as to whether the shader engine is deemed to be overloaded due to an excess amount of work (block 411). In various implementations, determining the shader engine is overloaded includes a comparison of a number of work items to a threshold, a number of work items currently waiting to be locally scheduled (i.e., pending work items), and so on. If such a condition is not detected, then the process returns to block 404 where processing continues.

If an overload condition is detected (block 411), then the global scheduler is notified (block 413), and one or more work items are sent (or “exported”) from the shader engine to an external shared cache 415. In this manner, work items are transferred from one shader engine to another shader engine. In various implementations, when an overload condition is detected, the local scheduler conveys a signal, stores an indication in a location accessible to the global scheduler, or otherwise, to alert the global scheduler. After exporting one or more work items, if work items remain within the shader engine (block 408), processing continues at block 404. Otherwise, if it is determined by the local scheduler that no work items are available to schedule (conditional block 408, “no” leg), the local scheduler provides an underutilization indication at the external cache of the global processor (block 410). In an implementation, the global processor detects the underutilization indication via the external cache and conveys a corresponding indication to another shader engine. In response, the other shader engine exports surplus work items and writes them to the external shared cache to make them available for redistribution. After the new work items are available at the external cache, the local scheduler can retrieve (or otherwise receive) the new work items to be scheduled (block 412) and write them to its local cache. Once the new work items are picked by the local scheduler, the method continues to block 404, wherein the ADC can launch the new work items for consumption at the one or more workgroup processors as described above.

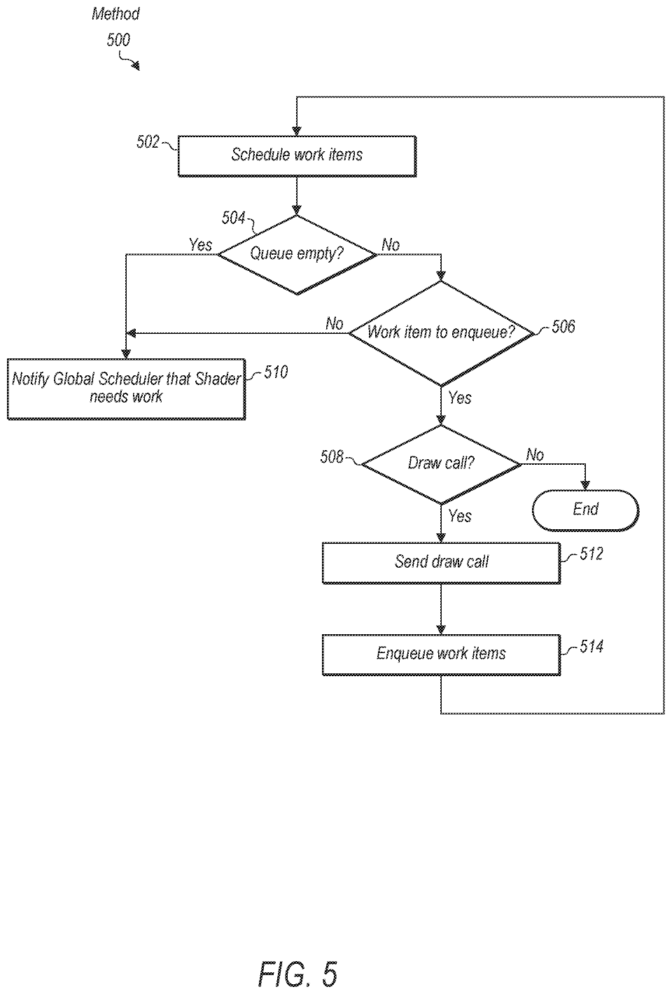

Turning now to FIG. 5, one implementation of a method 500 for local scheduling of work items is shown. A local scheduler of a shader engine is configured to schedule one or more work items for processing by workgroup processors of the shader engine (block 502). In an example, the local scheduler can use local atomic operations to schedule work items written to a local queue in a local cache of the shader engine. In case the local scheduler determines that the local queue is empty (conditional block 504, “yes” leg), the local scheduler can notify a global scheduler (e.g., the command processor 316 of FIG. 3) that the local scheduler has no work to schedule. In response, the global schedular is configured to determine if other shader engines have excess work available. If so, the global scheduler causes the other shader engine(s) to export the excess work by storing it in a cache shared by the shader engines (e.g., cache 314 of FIG. 3). The global scheduler then schedules the exported work to the shader engine that had previously indicated it had no work. In response, the local scheduler retrieves and schedules the work for execution on the shader engine. In this manner, work that would have remained enqueued on the other shader engine can begin execution and overall parallelism and performance is increased. This may be referred to as “stealing work” from another shader engine and the indication provided by a shader engine that it is out of work can be referred to as a “work steal” indication (block 510). In an implementation, the local scheduler can send the work steal by storing an underutilization indication at an external cache of the global processor.

Otherwise, if the local queue is not empty (conditional block 504, “no” leg), the local scheduler determines whether work items are available to enqueue (conditional block 506). If there are no work items to be enqueued (conditional block 506, “no” leg), the local scheduler again sends a work steal as shown in block 510. Otherwise, if work items are available to be enqueued (conditional block 506, “yes” leg), the local scheduler further determines if at least one work item comprises a draw call (conditional block 508). If no work item indicates a draw call, the method 500 may terminate (conditional block 508, “no” leg). Otherwise, the local scheduler issues the draw call (block 512). The local scheduler can then again enqueue work items to be scheduled (block 514) and the method 500 can continue to block 502, wherein these enqueued work items are scheduled by the local scheduler.

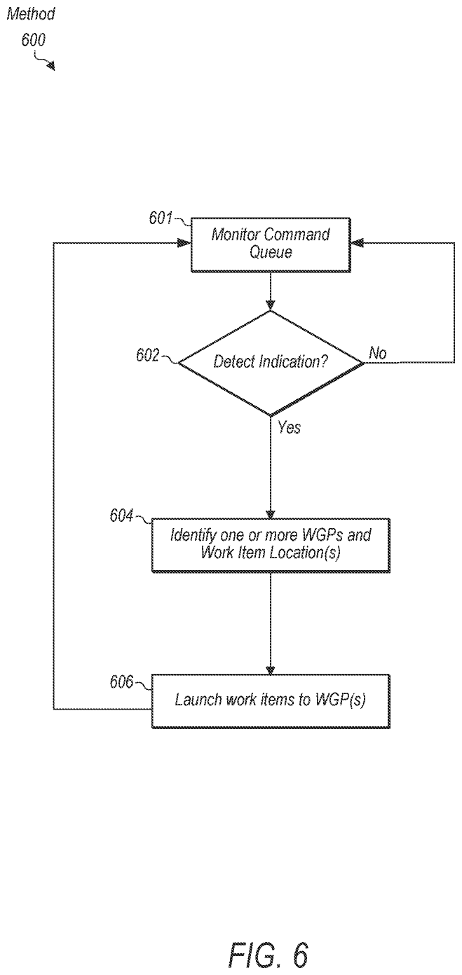

Turning now to FIG. 6, one implementation of a method 600 for launching work items by a dispatch controller (ADC) is shown. In various implementations, when the local scheduler of a shader engine initiates scheduling of work items, it stores or otherwise conveys an indication that is detectable by the ADC. The indication includes a command that is stored in a command queue that is monitored by the ADC (601). If the ADC determines that work items to be launched are available (conditional block 602, “yes” leg), the ADC initiates launch of the available work items to the workgroup processors. The ADC identifies one or more WGP to which work is to be distributed and where the work items are currently stored in the local cache (block 604). For example, in one implementation the WGP(s) and work item location(s) are indicated by the command. Based on this command, the ADC communicates with the identified WGP(s) to cause them to consume the work items (block 606). In case it is determined by the ADC that no work items are available to be launched (conditional block 602, “no” leg), the ADC continues monitoring (block 601).

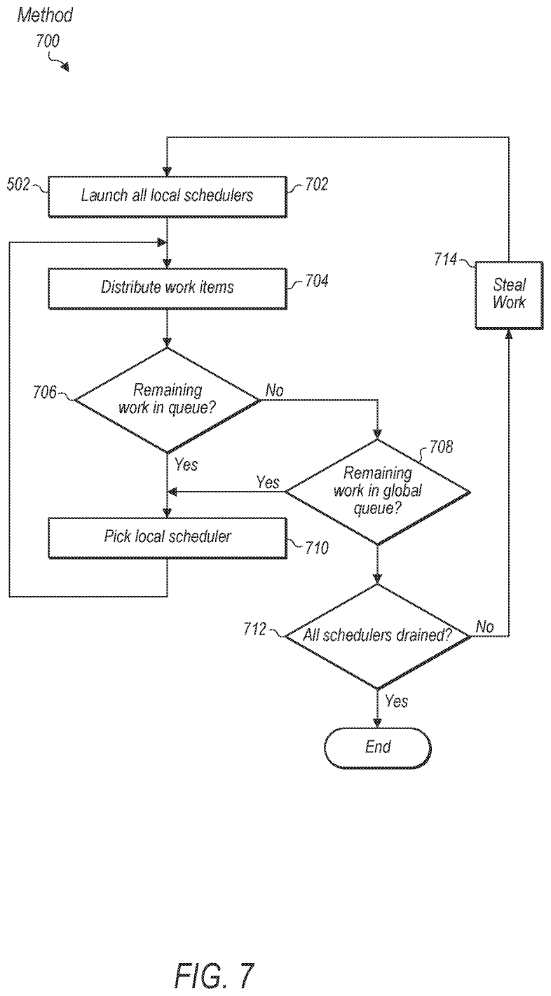

Turning now to FIG. 7, one implementation of a method for global scheduling of work items is shown. A global scheduler launches all local schedulers in a given hierarchy (block 702). For example, with reference to FIG. 3, all local schedulers 306 of shader engines 304 corresponds to a same level in the scheduling hierarchy. Once these local schedulers are launched, the global processor distributes the work items to each launched local scheduler (block 704). In an implementation, the global processor can distribute work items to the local schedulers by storing the work items in an external shared cache (e.g., cache 314 of FIG. 3). Further, the external cache may store these work items in a work queue local to the global processor, from where these are distributed to the local schedulers by the global processor. The global scheduler can then communicate a signal directly to local schedulers indicating work is available and where it is stored. In response, the local schedulers can retrieve and schedule work items as described in FIG. 5.

The global processor can then determine whether one or more work items are remaining for distribution (conditional block 706). If the global processor determines that work items are available in the local queue (conditional block 706, “yes” leg), the global processor selects a local scheduler for distribution of the remaining work items (block 710). Otherwise, if no work items remain in the local queue (conditional block 706, “no” leg), the global processor determines whether work items for distribution are present in a global queue (conditional block 708). If such work items are available (conditional block 708, “yes” leg), the method 700 continues to block 710 where global processor picks one or more local schedulers for distribution of the work items. Otherwise, if no such work items remain (conditional block 708, “no” leg), the global processor can determine if all local schedulers are drained (i.e., have completed their work) (conditional block 712). If the global processor determines that all the local schedulers are drained (conditional block 712, “yes” block), the method 700 ends. However, if all local schedulers are not drained (conditional block 712, “no” block), the global scheduler attempts to steal work from one or more shader engines for distribution to other shader engines (block 714). As discussed above, when a shader engine has excess work, such work can be redistributed to other shader engines that have no (or less) work in order to increase overall performance. The method 700 continues to block 702 and the process repeats.

In some implementations, local schedulers are configured to monitor/poll a memory location(s) for an indication that work is available. For example, a dedicated memory location (or “mailbox”) is maintained for each local scheduler where a semaphore type indication is maintained. When the global scheduler has work for a given local scheduler, the global scheduler stores an indication or message for the given local scheduler in its mailbox. In various implementations, the local scheduler can use this mailbox to communicate with the global scheduler. For example, the local scheduler can inform the global scheduler that it needs more work by writing to the mailbox. These and other implementations are possible and are contemplated.

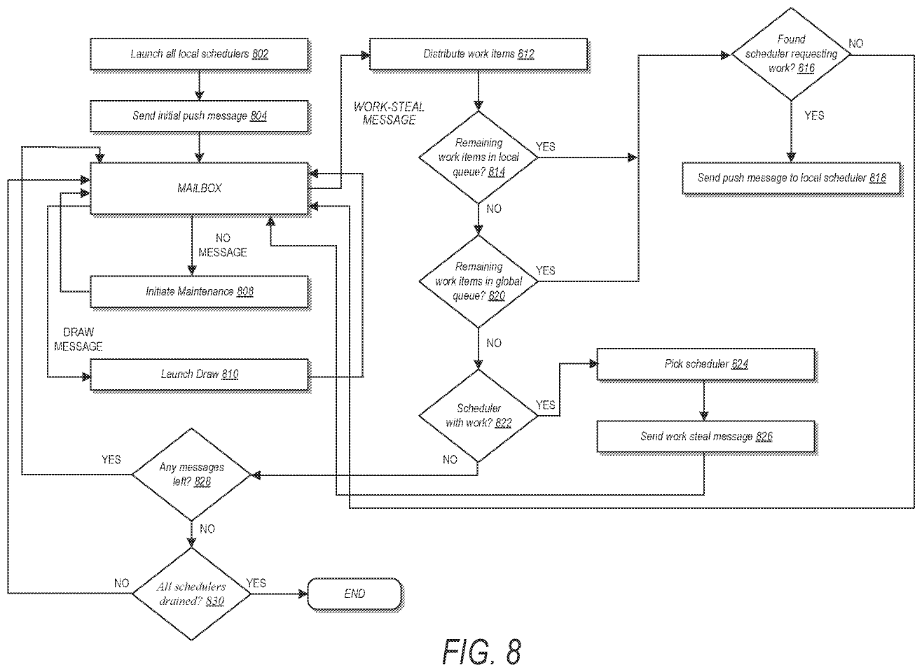

In other implementations, each local scheduler in the shader engines (i.e., the WGS) may have access to dedicated mailboxes to communicate with the global scheduler in a point-to-point fashion. That is, whenever a local scheduler communicates with the global scheduler (e.g., for conveying work steal, overload, or other indications), the local scheduler sends a message directly to a dedicated mailbox associated with the global scheduler bypassing an internal memory subsystem of the parallel processor. Further, the global scheduler can access the messages stored in the dedicated mailbox and respond with appropriate messages that are in turn stored at the dedicated mailbox of the local scheduler. In an implementation, each local scheduler may only access a single mailbox while the global scheduler may access multiple mailboxes. In several other implementations, one or more mailboxes may also be implemented in workgraph processors (WGPs) based on various implementations of the parallel processor described herein. In an example, each WGP may be associated with a dedicated mailbox, and similar to mailboxes implemented for the local schedulers, each WGP may only access a single mailbox at a time to communicate individually with another WGP, a local scheduler or the global scheduler. An exemplary implementation of dedicated mailboxes for hierarchical scheduling is as described in FIGS. 8-11.

Turning now to FIG. 8, one implementation of a method 800 for passing messages by a global scheduler using a dedicated mailbox, is shown. As described in the foregoing, the global scheduler launches all local schedulers for executing work items (block 802). In order to initiate the launch of each of the local schedulers (e.g., from a drained state to an active state as will be described below), the global scheduler sends an initial push message to each local scheduler (block 804). Once all local schedulers have been launched, the global scheduler accesses a dedicated mailbox to identify one or more messages stored in said mailbox. If there are no messages stored, the global scheduler can initiate a maintenance schedule (block 808). In various implementations, maintenance performed by the global scheduler includes evaluating received work and sorting, partitioning, merging, and/or otherwise manipulating the work to facilitate better distribution for scheduling. For example, a maintenance procedure may run in a WGP or as part of the WGS on a larger set of work items in an effort to build consecutive runs of work items with similar characteristics. In one example, messages received from local schedulers may contain varying amounts of work. During a maintenance schedule, the global scheduler will merge or split work proactively to form appropriately sized work available for distribution as soon as a local scheduler requests more work (e.g., via a work steal message). Further, due to scheduling of partial work items, accumulated work at each local scheduler may degrade over time such that unfavorable utilization of the processing (e.g., SIMD) units results. In order to reduce these types of scenarios, the global scheduler performs maintenance on received work to form workloads that result in better utilization of the SIMD unit. Various such implementations are possible and are contemplated.

In an implementation, the mailbox comprises a command queue configured to store messages received from local schedulers. Further, the command queue is configured to store a predetermined number of messages in a first-in-first-out mode. The number of messages that can be stored in the command queue, in one implementation, may increase as the processing is scaled up with the increase in the number of shader engines.

In one implementation, if a draw message is read by the global scheduler, it launches a draw operation (block 810) to a graphics subsystem (in an implementation, the local schedulers may not be able to issue draw commands themselves, and only the global scheduler are configured to issue the draw commands). In another implementation, if a work steal message is read from the mailbox, as received from a local scheduler, the global scheduler can distribute work items to the requesting local scheduler. As discussed above, in one implementation, the global scheduler conveys a work steal message to one or more local schedulers which may then export work items and store them in the external shared cache. Once such exported work items are globally visible (to the global scheduler and local schedulers), the global scheduler can then distribute the work items to a local scheduler that issued the work steal message (e.g., cache 314 of FIG. 3). The local scheduler then retrieves the work items from the external cache.

The global scheduler then determines whether there are one or more work items remaining in an entry queue configured to store new work received by the global scheduler (e.g., work generated by a processing unit) (conditional block 814). In various implementations, such work generated by processing units is pushed to the global scheduler. In case the global scheduler determines that there are one or more work items in the entry queue (conditional block 814, “yes” leg), the global scheduler can further determine whether there are one or more local schedulers requesting work (e.g., local schedulers from which work steal requests were previously received) (conditional block 816). If such a local scheduler(s) is identified, the global scheduler can send a push message to the local scheduler(s) (block 818) by storing the message in a dedicated mailbox(es) associated with the local scheduler(s). The local scheduler(s), in response to reading the push message, can then retrieve and distribute the work to one or more local processors. Otherwise, if no such local schedulers are found (conditional block 816, “no” leg), the global scheduler rechecks its own mailbox for new messages.

Referring again to conditional block 814, if the global scheduler identifies that there are no work items remaining in the entry queue (“no” leg), the global scheduler can further identify if work items remain in a global queue (conditional block 820). If work items remain in the global queue (conditional block 820, “yes” leg), the method 800 continues to block 816, wherein the global scheduler again finds local scheduler(s) looking for work. Otherwise, if there are no work items in the global queue (conditional block 820, “no” leg), the global scheduler determines if one or more local schedulers have surplus work (e.g., owing to overloading of a local scheduler) (conditional block 822). If such a local scheduler(s) is found (conditional block 822, “yes’ leg), the global scheduler can select the local scheduler(s) (block 824) and send a work steal message to a dedicated mailbox of the local scheduler(s) (block 826). In an implementation, the work steal message can indicate that another local scheduler is requesting work from the global scheduler. Further, once the identified local scheduler(s) with surplus work reads the work steal message, it can store the surplus work items to a cache local to the global scheduler. The global scheduler can then proceed to distribute the surplus work items to one or more local schedulers looking for work.

Referring again to conditional block 822, if no such local scheduler(s) are found (“no” leg), the global scheduler can determine whether there are any messages remaining in the mailbox (conditional block 828). If there are remaining messages (conditional block 828, “yes” leg), the global scheduler can read from the mailbox and take appropriate action (e.g., draw calls, work steal, scheduling, etc.). However, if no messages are left in the mailbox (conditional block 828, “no” leg), the global scheduler can determine whether all local schedulers are drained, i.e., have consumed all distributed work (conditional block 830). If all local schedulers are drained (conditional block 830, “yes” leg), the method 800 ends. Otherwise, the global scheduler continues checking the mailbox for new messages (conditional block 830, “no” leg).

In one implementation, the local scheduler can refrain from sending messages to the global scheduler's mailbox when a predetermined number of messages are already stored in the mailbox, or it is otherwise determined the global scheduler cannot receive a new message from the local scheduler. For example, a local scheduler may push work items to the global scheduler until an associated mailbox at the global scheduler is full or it is otherwise determined it can take no more messages. In such a case, the local scheduler will then stop sending messages to the associated mailbox until it can continue (e.g., the mailbox is no longer full). In various implementations, by ensuring a properly sized mailbox at each local scheduler, the global scheduler will always find space in the mailbox for a message and the global scheduler will never be blocked. It will thus be able to consume work from the mailbox that is associated with the blocked scheduler (i.e., a local scheduler that has temporarily stopped sending messages due to a full mailbox), which will eventually make space for a new message.

In yet another implementation, the global scheduler is configured to periodically check for new messages in its mailbox for a certain period of time (e.g., until a timeout period expires). For instance, a read message action for a given mailbox may fail if no messages arrive at the mailbox within a given period of time (e.g., a timeout period). Furthermore, the global scheduler, in an exemplary implementation, is always able to consume from its own mailbox. This in turn ensures that the entire processing system does not hang, even when the local schedulers have blocked sending of messages when they have sent more push messages than the command queue is configured to store. Any “blocking” send means that the sender will not progress its execution until the message could safely be placed into the mailbox (we would have to wait if the mailbox is full). In an implementation, any “non-blocking” send/receive from a scheduler (local or global) may indicate that the sender transmits/receives a message without scrutinizing whether the message can find a slot in an intended mailbox (usually successful transmission/receipt is guaranteed, for example, by having mailboxes with adequate storage) and therefore doesn't wait to execute the next instruction.

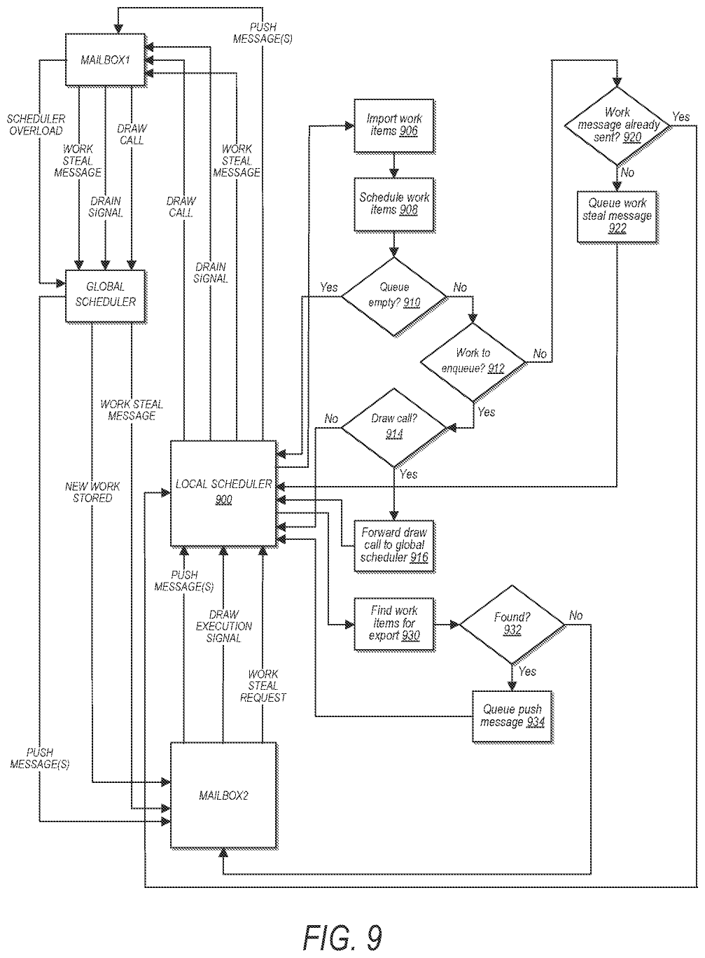

Turning now to FIG. 9, one implementation of a method 900 for passing messages by local schedulers using a dedicated mailbox is shown. A local scheduler 900, in one implementation, may send messages directly to the mailbox associated with a global scheduler (“mailbox 1”) and read messages from its own dedicated mailbox (“mailbox 2”). Similarly, the global scheduler can read messages from its own mailbox 1 and send messages to each local scheduler's dedicated mailbox (herein local scheduler 900 mailbox 2).

The method starts at block 906 wherein local scheduler 900 imports incoming work items from the global scheduler. In one implementation, the global scheduler can identify one or more local schedulers for new work items to be executed. Once these new work items are ready, the global scheduler can store the new work in a cache accessible by the one or more local schedulers. Further, to notify the one or more local schedulers that new work is available, the global scheduler can store a message in mailbox 2 (shown as “New Work Stored”) indicating the same. In an example shown in FIG. 9, the local scheduler 900 checks mailbox 2, reads the “New Work Stored” message, and retrieves the work from the cache. In one implementation, the “New Work Stored” message comprises information pertaining to a location in the cache where the work is stored.

Based on the work items received from the global scheduler, the local scheduler 900 can schedule the work items to be distributed to one or more local processors (block 908). The work imported by the local scheduler is scheduled to be executed by the one or more local processors, as described in conjunction with FIG. 4.

The local scheduler then checks in its local queue to determine whether one or more work items remain for scheduling (conditional block 910). If the queue is empty (conditional block 910, “yes” leg), the local scheduler identifies that it is in a drained state and sends a drain state message to the global scheduler's mailbox 1 (shown as “Drain Signal”). The global scheduler reads the “Drain Signal” from mailbox 1 (as shown) and then forwards the “Drain Signal” (in an implementation, as a work steal message) to one or more other local schedulers. It is noted that while forwarding of the “Drain Signal” message is described, in various implementations a message corresponding to the received “Drain Signal” is sent to the other local schedulers. In other words, the message sent to the other local schedulers is not the same “Drain Signal” that was received. In other implementation, the received “Drain Signal” message itself is forwarded as is to the other local schedulers.

Referring again to conditional block 910, if the queue for the local scheduler 900 is not empty (conditional block 910, “no” leg), the local scheduler 900 determines whether there is more work to enqueue (conditional block 912). If there is more work to enqueue (“yes” leg), the local scheduler 900 further identifies if the remaining work includes a draw call (conditional block 914). If there is a draw call (conditional block 914, “yes” leg), the draw call is initiated by local scheduler 900. In an implementation, when the draw call is initiated by the local scheduler 900, the draw call can be scheduled by the local scheduler to one or more local processors for execution.

However, in another implementation, the local scheduler 900 may directly forward the draw call to the global scheduler (block 916) in the form of a “Draw Call” message to mailbox 1. The “Draw Call” message is read by the global scheduler (as shown), such that a draw execution may be distributed to the processing system.

In another implementation, when the local scheduler 900 has more than a threshold amount of work, (i.e., has a huge dispatch or has a draw call) the work may be pushed to the global scheduler so that it can be distributed elsewhere in the processing system. In this manner, the local scheduler 900 and global scheduler cooperate to enable load balancing within the system. Otherwise, if the remaining work does not include a draw call (conditional block 914, “no” leg), the local scheduler 900 enqueues the remaining work. Once the work has been enqueued, the local scheduler 900 checks the mailbox 2 for new messages. In an implementation, each processing entity having a dedicated mailbox access may periodically check their respective mailboxes for new messages. Further, if no new messages (or no pending messages) exist in a mailbox, a maintenance operation may be initiated by the owner of the mailbox (as described in the subsequent text).

Referring again to conditional block 912, if no work is left to enqueue (“no” leg), the local scheduler 900 initiates finding of new work items. To this end, the local scheduler 900 determines whether a work steal message has already been sent to the global scheduler for requesting new work (conditional block 920). If work steal message has already been dispatched (conditional block 920, “yes” leg), the local scheduler 900 can check mailbox 2 for new messages indicative of receipt of new work items (e.g., “New Work Stored” message). However, if it is determined that a work steal message has not been sent, the local scheduler 900 can queue a work steal message (block 922) and send the work steal message to the global scheduler at mailbox 1 (shown as “Work Steal Request”).

In an implementation, the mailbox 2 may be empty or contain multiple messages, each of which may be processed differently by the local scheduler 900. For instance, when no messages are stored in the mailbox 2 (or no new messages are pending), the local scheduler can initiate a maintenance operation. Once the maintenance operation is complete, the local scheduler can continue scheduling work to one or more local processors for consumption (block 908).

In various implementations, different messages may be shared between the local scheduler 900 and the global schedulers using their respective dedicated mailboxes. For instance, local scheduler 900 can send one or more push messages to the global scheduler's mailbox 1. In one instance, for example, a push message can comprise an indication of surplus work and/or overloading. In another implementation, the local scheduler 900 can also send work steal messages to the global scheduler's mailbox 1 to indicate a drained state requesting work from the global scheduler.

On the other hand, the global scheduler can also send different messages to the local scheduler 900, at different times in an execution cycle. For instance, the global scheduler can send a new work stored message or a work steal message to local scheduler 900's mailbox 2. Apart from these messages, the global scheduler can also send messages such as exit messages or other push messages.

In an implementation, the local scheduler reads each of the one or more different messages received in its own mailbox, i.e., mailbox 2 in a first-in-first-out manner. In situations where a work steal message is received in the mailbox 2, from the global scheduler, indicating a request for work from another processor, the local scheduler determines if surplus work is available locally that can be exported to other (e.g., drained) local schedulers (block 930). In various implementations, the local scheduler indicates a number of work items that are pending (waiting to be scheduled) and conveys a response with this number to the global scheduler by writing it to mailbox 1 (e.g., in the form of a push message). In other implementations, the local schedulers identify work items as surplus if the number of pending work items exceeds a threshold. If such surplus work is found (conditional block 932, “yes” leg), the local scheduler can queue sending of a push message back to the global scheduler (block 934), and write the push message in mailbox 1, in response to which the global scheduler allows the local scheduler 900 to store the surplus work in a shared cache associated with the global scheduler (e.g., cache 314 as illustrated in FIG. 3).

However, if no surplus work is found (conditional block 932, “no” leg), the local scheduler 900 can send a work steal message to a next hierarchical level (i.e., the global scheduler in this case), for work to be stolen. The global scheduler can then send messages to one or more of the other local scheduler(s) to ask for work. If one of the other local schedulers has work to provide, it responds by exporting (or pushing) work to the global scheduler with the work (or an identification of a location of the work). In one example, a network-based scheme may be utilized where a mailbox for a local scheduler can also be written to by any other local schedulers without data being lost, as long as the data is merged into the destination mailbox (such as an OR or ADD command) and then sending a “wakeup” message after work has been enqueued to a target work queue. to find work to be forwarded to the global cache.

The local scheduler 900 after sending the work steal message can again check its mailbox 2 for new messages or pending messages. In one implementation, the local scheduler 900 keeps checking for messages until a timeout period expires. For example, in various implementations, each local scheduler(s) is configured to periodically poll for messages to determine if a new message has been received. In another implementation, global scheduler can send messages to the local scheduler 900 in the mailbox 2, blocking execution of subsequent instructions of the global scheduler until the send message has completed writing the message into the mailbox. In yet another implementation, the global scheduler can send messages to mailbox 2 in a non-blocking fashion. In those cases, the global scheduler may immediately execute a subsequent instruction and not wait until the send completed (i.e., sending message to the mailbox 2 and executing the subsequent instructions happens in parallel).

As described in the foregoing, local schedulers may communicate with each other or with one or more local processors using dedicated mailboxes, wherein in an implementation, each of the local schedulers and the local processors may only have access to a single mailbox. Further, local schedulers may receive work steal messages from the global scheduler, in their dedicated mailboxes. Once the global scheduler sends the work steal message, other local scheduler(s) can send an indication of surplus work back to the global scheduler, which is stored in mailbox 1 (read by global scheduler as “Scheduler Overload”). In response to the messages received from the local schedulers indicating whether they have work available to steal (e.g., pending work items not yet distributed to local WGPs), the global scheduler identifies one or more of the local schedulers from whom work will be taken. In some implementations, the messages received from the local schedulers will indicate how much work they have pending (e.g., based on a number of work items stored in a pending work queue(s)). Based on this indication, the global scheduler may prioritize and target those local schedulers that have the most work pending for work stealing and send a message to those local schedulers. In response, the local scheduler(s) export one or more work items to the external cache. In various implementations, the number of work items exported is indicated by the global scheduler. For example, based on an identified number of work items pending in each shader engine, the global scheduler can take a larger number of work items from those local schedulers that have a larger number of work items pending. In other implementations, the local scheduler determines how many work items to export. These and other implementations are possible and are contemplated.

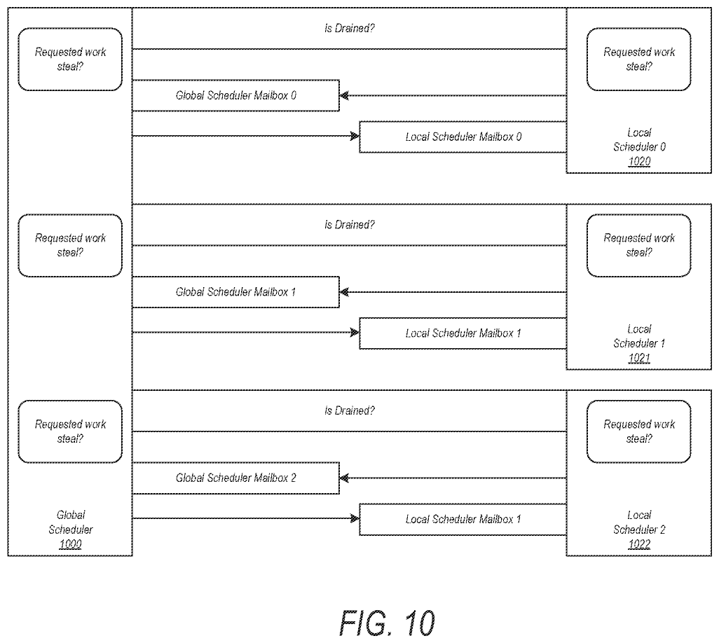

Turning now to FIG. 10, a 2-mailbox system for passing messages between individual schedulers, is shown. In the example, a global scheduler 1000 is configured to communicate with each of three local schedulers (1020, 1021, and 1022). As depicted in the figure, the global scheduler may have access to multiple mailboxes (denoted by global scheduler mailboxes 0, 1, and 2), while each of the local scheduler may only have access to a single mailbox each. For instance, in an implementation shown in the figure, local scheduler 0 has access to a local scheduler mailbox 0, the local scheduler 1 has access to local scheduler mailbox 1 and local scheduler 2 has access to local scheduler mailbox 2. In operation, each of the global scheduler mailboxes may start storing messages communicated from the local schedulers, beginning with a shared state, wherein in the shared state, each local scheduler is in the drained state (i.e., is looking for work for to consume).

Further, once any of the local schedulers identifies a drained state, it sends a work steal message to a dedicated mailbox associated with the global scheduler. For example, in one implementation shown, the local scheduler 0 conveys a work steal to the global scheduler by sending a work steal message that is received and stored in the global scheduler mailbox 0 (as shown by a directional arrow). Once the global scheduler reads the work steal message from local scheduler 0, it can send indication of new work items to the local scheduler's mailbox 0 (as shown by a directional arrow). In said implementation, the global scheduler can send the indication of new work to the local scheduler mailbox 0, when the global scheduler identifies unassigned work items in a global cache. Otherwise, in another implementation, the global scheduler can forward the work steal message to another local scheduler's mailbox, using a different mailbox (e.g., mailbox 1), from which an overload indication to the global processor was previously received (e.g., in the form of a push message).

In an implementation, the messages communicated between dedicated mailboxes of the global scheduler and one or more local schedulers may comprise work steal messages, push messages, exit messages, and the like. Other types of messages are contemplated and are within the scope of the present invention. Further, each message may only take a minimal amount of memory, e.g., 8 to 16 bytes. Each message may also comprise of a pointer and a message tag to identify the type of message. Optionally, some additional message data ranging from a message memory usage of 2 to 8 bytes may also be included in one or more messages. A dedicated empty message can be configured for each individual mailbox which can be returned to any receiver indicating that a given mailbox is empty.

In an implementation, any sender (local scheduler and/or global scheduler) can send a message to a command queue of a mailbox of a receiver without blocking execution of code. Further, each sender needs to wait to send a subsequent message until a confirmation of delivery of an initial message is received. In such a scenario, a receiver's mailbox may block one or more messages from the sender, if the receiver's mailbox has reached a predetermined number of stored messages.

In another implementation, a “blocking” send for the local scheduler may be initiated that may ensure that the local scheduler does not progress its execution until the message can safely be placed into the global scheduler's mailbox (i.e., there is room for the message). The global scheduler may also periodically check its mailbox for new messages till a predetermined timeout period expires. If no messages arrive, the global scheduler can execute other instructions and recheck the mailbox at another time.

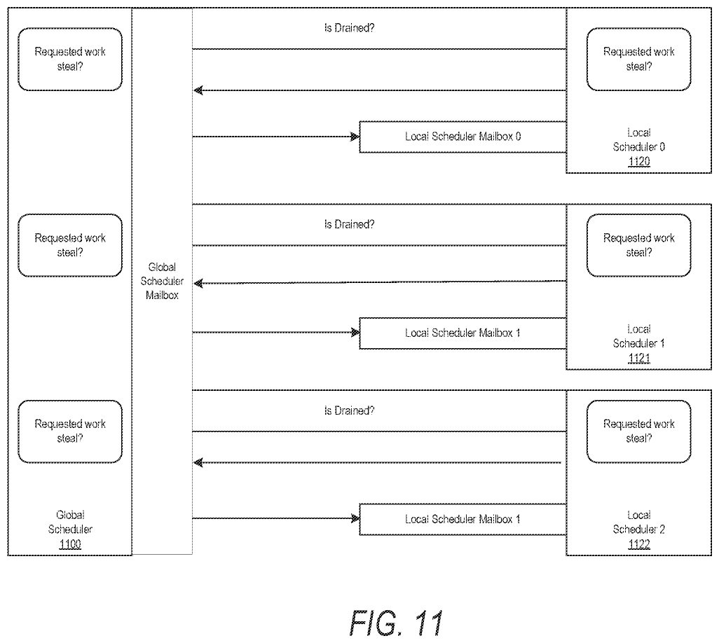

Turning now to FIG. 11, a single mailbox system for passing messages between individual schedulers, is shown. As depicted in the figure, the global scheduler may have access to a global mailbox (denoted by global scheduler mailbox), while each of the local schedulers may only have access to a single mailbox. For instance, in an implementation shown in the figure, local scheduler 0 has access to a local scheduler mailbox 0 and each of the local scheduler 1 and local scheduler 2 can access local scheduler mailbox 1. In operation, the global scheduler mailbox may start storing messages communicated from the local schedulers, beginning with a shared state, wherein in the shared state, each local scheduler is in the drained state (i.e., is looking for work for consumption).

In an implementation, for the single mailbox system to operate, each message from a sender to the global scheduler comprises the sender's address (or some other identification usable to identify the sender) as a part of the message. This may be done to identify a sender's information (e.g., which local scheduler is sending a message to the global scheduler). Further, similar to a 2-mailbox system, the messages communicated between the mailbox of the global scheduler and one or more local schedulers mailboxes may comprise work steal messages, push messages, exit messages, etc.

In an implementation, race conditions for local scheduler may be monitored. A race condition may be indicative of an error in execution that may arise from nondeterministic timing of execution. The race condition may be related to a problem of detecting when all local schedulers are completely drained and there is no more work left to be executed in the system. In an implementation, before exiting execution, the global scheduler must ensure that none of the local schedulers have remaining work. However, one or more push messages that are still stored at a local scheduler's mailbox might move the local scheduler out of a drained state. The race condition occurs if the global scheduler detects all schedulers in drained state, while at the same time local scheduler(s) read the push message(s) and recover from the drained state.

Due to the potential exit race conditions in execution of instructions by the local scheduler, a check is performed to determine whether pending messages are available in a given mailbox (e.g., local scheduler mailbox 0), without removing the pending messages from said mailbox. In order to do so, one or more actions may be performed, including but not limiting to, peek, count, and empty. A peek action can return a first message in a given mailbox (or empty message if there are no messages), whilst keeping the first message in the mailbox. A count action can return a total number of messages in the mailbox at a given time. Further, an empty action returns ‘true’ if there are no pending messages in the mailbox.

In another implementation, the potential race conditions can also be monitored by sending a message when transition of a local scheduler (e.g., local scheduler 0) to a drained state is identified. This in turn causes a ‘drained flag’ to be set if both the local scheduler mailbox and the global scheduler mailbox are empty. Further, any message sent after the transition, clears the drained flag. In one implementation, a shared state of the local schedulers must be readable by the global scheduler.

In various implementations, mailboxes can only be read from, or written to, atomically. As used herein, an atomic operation (read or write) refers to an operation that cannot be interrupted before completion. Atomic operations can be enforced via spinlocks or any other suitable mechanism, as the mailboxes are waited for, and may only be written or read atomically, message passing techniques described herein can enable atomic synchronization by having, for example, one mailbox with one scheduler waiting for to be filled while another scheduler can signal the mailbox, once all work at the other scheduler is consumed. In another implementation, waiting for a set of message boxes to have a message may be realized, which would allow a N:1 synchronization (for example, the global scheduler could wait for all local schedulers to post one message.)

In several implementations, methods and systems described herein may allow implementation of mailboxes by allocating globally accessible memory and performing an atomic spin-lock to guard access to these mailboxes. In an implementation, a single value may be reserved for a given processor accessing a mailbox. Another processor wanting to access the mailbox may then exchange that value using an atomic compare exchange, effectively guarding access to the mailbox. For example, if ‘0’ is indicative of the mailbox not being accessed, and 1′ means mailbox is currently locked, a new actor might try to compare exchange a 0 with a 1. Based on the return value the actor will know if the exchange was successful (i.e., it acquired the lock) or unsuccessful (i.e., it must retry the same operation). On success the actor can perform any operation (send, peek, receive, etc.) and once the action is complete, the actor atomically writes a 0 to that value, indicating that another actor can now access the mailbox.

It should be emphasized that the above-described implementations are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A processor comprising:
a global scheduler;
at least one local scheduler; and
at least a first mailbox accessible by the global scheduler;
wherein the at least one local scheduler writes a first set of messages to the first mailbox to initialize a point-to-point communication with the global scheduler.

2. The processor as recited in claim 1, further comprising:
a second mailbox accessible by the at least one local scheduler;
wherein the global scheduler writes a second set of messages to the second mailbox in response to initialization of the point-to-point communication.

3. The processor as recited in claim 2, wherein the first mailbox comprises a command queue configured to store the first set of messages received from the at least one local scheduler.

4. The processor as recited in claim 3, wherein the command queue is configured to store a predetermined number of messages in a first-in-first-out mode.

5. The processor as recited in claim 2, wherein a message of the first set of messages comprises an indication that the second mailbox is empty.

6. The processor as recited in claim 1, wherein the local scheduler activates a blocking send to the global processor when a predetermined number of messages in the first mailbox is reached.

7. The processor as recited in claim 1, wherein the local scheduler pauses execution of an instruction until an acknowledgment of successful transmission and storage of a message to the first mailbox is received.

8. The processor as recited in claim 1, wherein the global processor checks for new messages in the first mailbox until a predetermined timeout period is reached.

9. The processor as recited in claim 1, wherein the point-to-point communication is initialized independent of a main memory subsystem associated with the processor.

10. A method comprising:
receiving, at a mailbox associated with a global scheduler, a first message from a local scheduler coupled to one or more processors;
retrieving, responsive to the first message, one or more work items from a global cache; and
exporting, by the global scheduler, the one or more work items for execution by the one or more processors coupled to the local scheduler.

11. The method as recited in claim 10, further comprising writing, by the global scheduler, a second message to a second mailbox associated with the local scheduler in response to receiving the first message, thereby initiating a point-to-point communication with the local scheduler.

12. The method as recited in claim 11, wherein the point-to-point communication is initialized independent of a main memory subsystem associated with the processor.

13. The method as recited in claim 10, wherein the mailbox associated with the global scheduler comprises a command queue configured to store the first message.

14. The method as recited in claim 13, wherein the command queue is configured to store a predetermined number of messages in a first-in-first-out mode.

15. The method as claimed in claim 10, wherein the first message comprises an indication that the local scheduler is in a drained state.

16. The method as recited in claim 15, further comprising, pausing, by the global scheduler, execution of an instruction until an acknowledgment of successful transmission and storage of a message to the mailbox associated with the local scheduler is received.

17. The method as claimed in claim 10, further comprising, periodically checking, by the global processor, arrival of one or more new messages in the mailbox associated with the global scheduler, until at least one new message is received from the local scheduler.

18. The method as claimed in claim 17, further comprising, periodically checking, by the global processor, arrival of one or more new messages in the mailbox associated with the global scheduler, until a predetermined timeout period is expired.

19. A computing system comprising:
a central processing unit;
a memory controller; and
a graphics processing unit comprising:
a global scheduler;
at least one local scheduler; and
at least a first mailbox accessible by the global scheduler;
wherein the at least one local scheduler writes a first set of messages to the first mailbox to initialize a point-to-point communication with the global scheduler.

20. The computing system of claim 19, further comprising:
a second mailbox accessible by the at least one local scheduler;
wherein the global scheduler writes a second set of messages to the second mailbox in response to initialization of the point-to-point communication.
